(19) United States
(12) Patent Application Publication
(10) Pub. No.: US 2026/0300088 A1
(43) Pub. Date: Oct. 1, 2026

(54) APPARATUS WITH ADAPTIVE ERROR HANDLING MECHANISM AND METHODS FOR OPERATING THE SAME

(71) Applicant: Micron Technology, Inc., Boise, ID (US)

(72) Inventor: Seshasai Vamsi Krishna Peddinti, Puppalguda (IN)

(21) Appl. No.: 19/543,816

(22) Filed: Feb. 18, 2026

Related U.S. Application Data
(60) Provisional application No. 63/777,213, filed on Mar. 25, 2025.

(51) Int. Cl. G06F 11/10

(52) U.S. Cl. CPC G06F 11/1044

(57) ABSTRACT

Methods, apparatuses and systems related to selecting and maintaining partial decoding information according to real-time measures are described. An apparatus may select and maintain a portion or a subset of a full set of parity information according to the real-time measures that represent current sources of data corruption, historical patterns of data corruption, or a combination thereof. The apparatus can use the resulting subset, instead of the full set, to decode the raw data.

### CROSS-REFERENCE TO RELATED APPLICATION(S)

The present application claims priority to U.S. Provisional Patent Application No. 63/777,213, filed Mar. 25, 2025, the disclosure of which is incorporated herein by reference in its entirety.

### TECHNICAL FIELD

The disclosed embodiments relate to devices, and, in particular, to semiconductor memory devices with adaptive error handling mechanisms and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. Conventional semiconductor devices have inherent physical characteristics that introduce errors with respect to data storage and access.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2 is a block diagram of an example adaptive error handling mechanism in accordance with an embodiment of the present technology.

FIG. 3 is a flow diagram illustrating an example method of operating an apparatus in accordance with an embodiment of the present technology.

FIG. 4 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for adaptively handling errors according to real-time conditions. In some embodiments, the apparatus can use a portion (e.g., a partial matrix) within a full set of error correcting code (e.g., one or more full matrix) according to real-time conditions, such as Signal-to-Noise Ratio (SNR), Average Mutual Information (AMI), Bit Error Rate (BER), and/or the like.

For context, computing devices can use error correction code (ECC) that can be used to detect and correct errors within a unit of data. The relationship between the data and the ECC can follow a predetermined mechanism, such as Bose-Chaudhuri-Hocquenghem (BCH) code, Reed-Solomon (RS) code, parity check, Low-Density Parity Check (LDPC), and the like. Some categories of ECC codes can provide more advantages for certain applications. For example, algebraic codes (e.g., BCH and RS) may be inadequate for usage in some memory devices, such as Solid-State Drives (SSDs), NAND flash devices, etc. Instead, other categories of ECC, such as the LDPC, may be more adept to handle characteristics unique to memory devices (e.g., memory channel degradations, frequent memory access, etc.). However, even the more adept code categories can have disadvantages, such as typically higher power consumption for LDPC in memory devices as compared to BCH and RS codes.

To reduce or eliminate the disadvantages of the error handling (e.g., the ECC mechanism), embodiments of the technology described herein can include an adaptive error handling mechanism that selectively leverages a portion of a full computational matrix for the ECC process. As an illustrative example, the LDPC code can utilize a parity-check matrix (also referred to as an H matrix) to detect and/or correct any errors introduced into the data. The adaptive error handling mechanism (e.g., software, hardware, firmware, or a combination thereof) can select and use a portion of the H matrix instead of its entirety according to the real-time parameters (e.g., channel conditions) that indicate the likeliness of errors within the data. For example, when the channel conditions are better (e.g., for newer devices) according to the SNR, the BER, the AMI, etc., the adaptive error handling mechanism can select and utilize a smaller portion of the H matrix for error handling. Otherwise, as the channel conditions worsen (e.g., according to the corresponding indicators, such as the SNR, the BER, the AMI, etc.), the adaptive error handling mechanism can select and utilize a larger portion of the H matrix.

By using a partial matrix that is sized and selected according to the real-time parameters (e.g., channel conditions), the apparatus can improve the resource efficiency associated the ECC computation. For example, by using the partial H matrix instead of the full H matrix for each ECC computation, the memory device can reduce the power consumption, the computation time/resource, and the like associated with the LDPC implementation. Moreover, by using the real-time parameters, such as the SNR and the AMI, the apparatus can select the appropriate portion of the H matrix, thereby preserving the overall accuracy of the decoding process. Additionally, the apparatus can account for any deficiencies caused by using the smaller matrix by iteratively assessing and adjusting the partial decoding results. The iterative assessment/adjustment process can be further leveraged to make adjustments to the partial matrix, thereby maintaining the appropriate partial matrix as the conditions of the apparatus changes.

### Example Environment

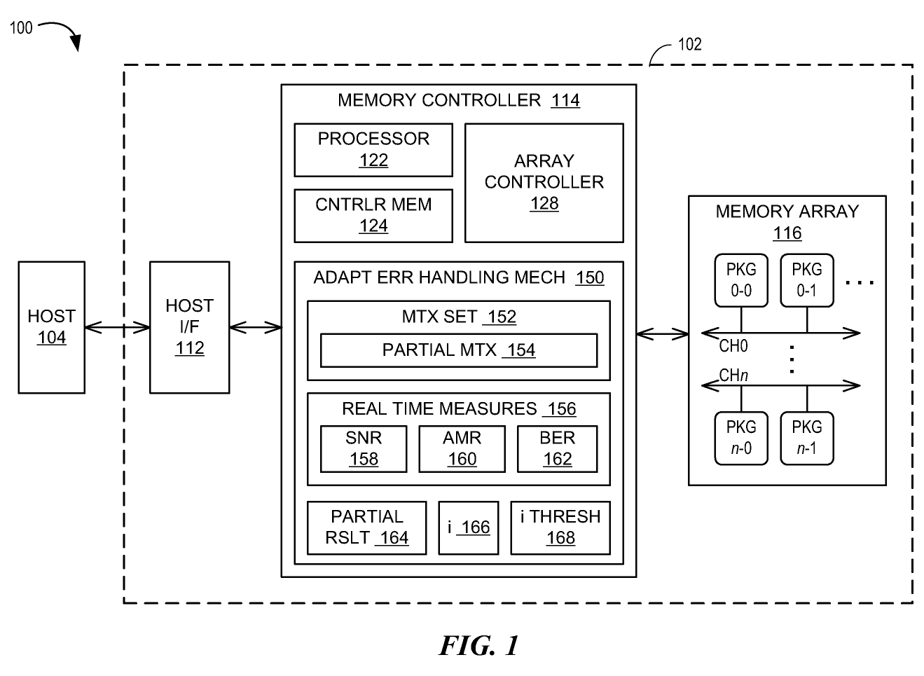

FIG. 1 is a block diagram of a computing system 100 in accordance with an embodiment of the present technology. The computing system 100 can include a personal computing device/system, a mobile device (e.g., a mobile/smart phone), a wearable device, an enterprise device, a server, a mainframe, or the like. The computing system 100 can include a memory system or subsystem 102 coupled to a host device 104. The host device 104 can include one or more processors that can write data to and/or read data from the memory system 102. For example, the host device 104 can include a central processing unit (CPU) controlling the operation of the computing system 100.

The memory system 102 can include circuitry configured to store data (via, e.g., write operations) and provide access to stored data (via, e.g., read operations). For example, the memory system 102 can include a persistent or non-volatile data storage system, such as a NAND-based Flash drive system, SSD, or the like. In some embodiments, the memory system 102 can include a host interface 112 (e.g., buffers, transmitters, receivers, and/or the like) configured to facilitate communications with the host device 104. For example, the host interface 112 can be configured to support one or more host interconnect schemes, such as Universal Serial Bus (USB), Peripheral Component Interconnect (PCI), Serial AT Attachment (SATA), Universal Flash Storage (UFS) protocol, or the like. The host interface 112 can receive commands, addresses, data (e.g., write data), and/or other information from the host device 104. The host interface 112 can also send data (e.g., read data) and/or other information to the host device 104.

The memory system 102 can further include a memory controller 114 and a memory array 116. The memory array 116 can include memory cells that are configured to store a unit of information. For example, the memory array 116 can include NAND dies or packages. The memory controller 114 can be configured to control the overall operation of the memory system 102, including the operations of the memory array 116.

In some embodiments, the memory array 116 can include a set of storage devices or corresponding packages. Each of the storage devices can include a set of memory cells that each store data in a charge storage structure. The memory cells can include, for example, floating gate, charge trap, phase change, ferroelectric, magnetoresistive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate a Vt of the cell. For example, a SLC can be programmed to a targeted one of two different data states, which can be represented by the binary units 1 or 0. Also, some flash memory cells can be programmed to a targeted one of more than two data states. Multi-level cells (MLCs) may be programmed to any one of four data states (e.g., represented by the binary 00, 01, 10, 11) to store two bits of data. Similarly, triple-level cells (TLCs) may be programmed to one of eight (i.e., 2³) data states to store three bits of data, and quadruple-level cells (QLCs) may be programmed to one of 16 (i.e., 2⁴) data states to store four bits of data.

Such memory cells may be arranged in rows (e.g., each corresponding to a word line) and columns (e.g., each corresponding to a bit line). The arrangements can further correspond to different groupings for the memory cells. For example, the memory groupings can include memory pages arranged according to word line. Also, the memory groupings can include memory blocks. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

As described above, the memory system controller 114 can be configured to control the operations of the memory array 116. The memory system controller 114 can include a processor 122, such as a special purpose logic circuitry (e.g., a field programmable gate array (FPGA), an application specific integrated circuit (ASIC), etc.), a microprocessor, or other suitable processor. The processor 122 can execute instructions encoded in hardware, firmware, and/or software (e.g., instructions) stored in controller embedded memory 124 to execute various processes, logic flows, and routines for controlling operation of the memory system 102 and/or the memory array 116.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

In controlling the operations of the memory system 102, the memory system controller 114 (via, e.g., the processor 122, the embedded memory 124, and/or the array controller 128) can implement a Flash Translation Layer (FTL). The FTL can include a set of functions or operations that provide translations for the memory array 116 (e.g., the Flash devices therein). For example, the FTL can include the logical-physical address translation, such as by providing the mapping between virtual or logical addresses used by the operating system to the corresponding physical addresses that identify the Flash device and the location therein (e.g., the layer, the page, the block, the row, the column, etc.). Also, the FTL can include a garbage collection function that extracts useful data from partially filed units (e.g., memory blocks) and combines them to a smaller set of memory units. The FTL can include other functions, such as wear-leveling, bad block management, concurrency (e.g., handling concurrent events), page allocation, error correction code (e.g., error recovery), or the like.

The memory system 102 can include an adaptive error handling mechanism 150 (e.g., software, hardware circuitry, logic, firmware, or a combination thereof) configured to dynamically adjust the ECC process according to real-time conditions. In some embodiments, the adaptive error handling mechanism 150 can be configured to process a matrix set 152 (e.g., a full H matrix for LDPC ECC) to select or derive one or more partial matrices 154 (e.g., one or more portions of the H matrix).

The adaptive error handling mechanism 150 can select or derive the partial matrices 154 according to one or more real-time measures 156 representative of data processing/access conditions (e.g., channel conditions). The adaptive error handling mechanism 150 can use the real-time measures 156 as inputs for selecting an initial partial matrix that may be subsequently updated according to decoding results and/or predetermined triggers (e.g., timing/frequency, iteration counts, errors, etc.). The adaptive error handling mechanism 150 can use the real-time measures 156 as the selection input controls in addition to or instead of using such measures to evaluate the decoding results. Some examples of the real-time measures 156 can include SNR 158, AMI 160, BER 162, or a combination thereof.

The SNR 158 can be computed from a result of communicating a known signal over a processing channel, such as in accessing values from the memory array 116. The SNR 158 can be computed based on a difference between the known signal/value and the obtained result. In some embodiments, the adaptive error handling mechanism 150 can compute the SNR 158 based on a sensing voltage used to access the stored data. The adaptive error handling mechanism 150 can track an expected level for the sensing voltage according to an estimated charge loss due to retention capacity of the cells (e.g., program/erase count), charge retention time, previous errors associated with the cells, and/or the like. The adaptive error handling mechanism 150 can compute the SNR 158 based on the expected sensing voltage and the actual sensing voltage used to access or read the data from the targeted cells.

The AMI 160 can represent a measure of an amount or a degree of overlap of information (e.g., mutual information) in two random variables. The AMI 160 can quantify a statistical dependence between two signals, such as for an initial communication of a signal and a corrected output of the signal. In some embodiments, the adaptive error handling mechanism 150 can compute the AMI 160 based on tracking a difference (e.g., a number of corrected bits, a corresponding number of amount of change in the signal voltages, etc.) between the initially accessed/read raw data and the corrected data corresponding result of performing the ECC computation on the raw data.

In some embodiments, the adaptive error handling mechanism 150 can be configured to select, according to the real-time measures 156, one of the partial matrices 154 that correspond to predetermined subgroupings or divisions within the matrix set 152. In other embodiments, the adaptive error handling mechanism 150 can use a predetermined process or equation to dynamically divide or subgroup portions within the matrix set 152 according to the real-time measures 156.

Using the selected/derived partial matrix 154, the adaptive error handling mechanism 150 can compute a partial result 164 according to the ECC mechanism. Using the LDPC example, the error handling mechanism 150 can perform the ECC computations using the dynamically selected partial H matrix (instead of the full H matrix) to compute the partial result 164. Accordingly, the corresponding size of the computed matrices can be reduced. Moreover, the reduced size can provide improved system efficiencies by reducing the number of reads and write that would otherwise associated with the larger matrix.

For the overall ECC computation, the adaptive error handling mechanism 150 can iteratively select/derive the partial matrix 154 corresponding to different portions of the matrix set 152 and compute the corresponding partial result 164. The adaptive error handling mechanism 150 can repeat the process until one or more threshold conditions are met. For example, the adaptive error handling mechanism 150 can use the partial matrix 154 to compute a full message set when the partial result 164 satisfies a performance threshold (e.g., a satisfactory ECC result, such as sufficient Log-Likelihood Ratios (LLRs)) and/or an iteration tracking count 166 (shown as i in FIG. 1) remains under a corresponding iteration threshold 168. When the iteration tracking count 166 reaches or exceeds the corresponding iteration threshold 168, the adaptive error handling mechanism 150 can use the full matrix set 152, such as by combining the previous values of the partial results 164 across the iterations or by performing a full ECC computation using the full matrix set 152.

### Example Architecture

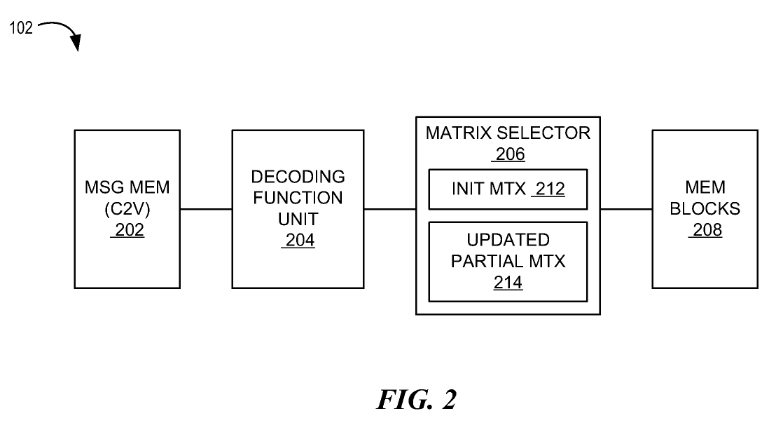

FIG. 2 is a block diagram of an example adaptive error handling mechanism in accordance with an embodiment of the present technology. FIG. 2 can correspond to an architecture (e.g., hardware and/or software architecture) for the ECC processing with the adaptive error handling. In some embodiments, the memory system 102 can include a message memory 202, a decoding function unit 204, and/or a matrix selector 206 corresponding to the adaptive error handling mechanism 150 of FIG. 1.

The message memory 202 can include memory (e.g., buffers, local cache, and/or the like) local to the memory controller 114 of FIG. 1 and/or the memory array 116 of FIG. 1. The message memory 202 can be configured to store raw/accessed data before the ECC computation, processing results of the ECC computation, portions thereof, or a combination thereof. For the LDPC example, the message memory 202 can be used to store (1) Check-to-Variable (C2V) messages that correspond to information passed from a check node to a variable node, (2) Variable-to-Check messages (V2C) that correspond to information passed from a variable node to a check node during the ECC computation.

The decoding function unit (also referred to as DFU) 204 can include circuitry (e.g., logic), instructions or code, firmware, or a combination thereof configured to decode the raw/accessed data according to the ECC mechanism. For the LDPC example, the DFU 204 can perform the decoding operation for the ECC.

The adaptive error handling mechanism 150 can include the matrix selector 206 coupled to the DFU 204. The matrix selector 206 can include circuitry (e.g., logic), instructions or code, firmware, or a combination thereof configured to obtain the partial matrix 154 of FIG. 1. In some embodiments, the memory system 102 can include a predetermined set of partial matrices in the matrix set 152 of FIG. 1 that correspond to the full H matrix. In other words, the matrix set 152 can include a predetermined set of divisions of the full H matrix. Accordingly, the matrix selector 206 can select one of the predetermined divisions as the partial matrix 154 from the matrix set 152. In other embodiments, the matrix selector 206 can be configured to dynamically derive the partial matrices 154 from the full H matrix according to a predetermined process, equation, or the like.

In obtaining the partial matrix 154, the matrix selector 206 can be configured to select an initial partial matrix 212 corresponding to an initial portion of the matrix set 152. The adaptive error handling mechanism 150 (via, e.g., the DFU 204 and/or the matrix selector 206) can select or compute the initial matrix 212 according to the real-time measures 156. For example, the adaptive error handling mechanism 150 can select or compute the initial matrix 212 using a predetermined lookup table, equation, routine, and/or the like that uses the SNR 158 of FIG. 1, the AMI 160 of FIG. 1, and/or the BER 162 of FIG. 1. Effectively, the adaptive error handling mechanism 150 can compare the BER 162 to the SNR 158 and compare the BER 162 to the AMI 160 to evaluate the channel condition. Based on the analysis results, the adaptive error handling mechanism 150 can dynamically select as the initial matrix 212 one corresponding partial matrix or portion of the full H matrix from the matrix set 152.

Once selected, the adaptive error handling mechanism 150 can use the initial partial matrix 212 to perform the ECC computation. During the computation, the adaptive error handling mechanism 150 can derive one or more metrics to assess the effectiveness of the initial partial matrix 212. For example, the adaptive error handling mechanism 150 can determine whether the initial partial matrix 212 produces errors. Also, in response to errors, the adaptive error handling mechanism 150 can internally iterate based on computing likelihood values (e.g., LLRs) representative of whether one or more bits within the accessed raw data and/or the decoded output (e.g., the partial decoding result 164) are inaccurate. The adaptive error handling mechanism 150 can compute the LLR values at one or more stages or nodes within the ECC computation. The adaptive error handling mechanism 150 can check the nodes and adjust the LLR values according to a set of predetermined rules to account for the decoding failure. The adaptive error handling mechanism 150 can perform the partial decoding as a new iteration using the updated LLR values and/or other internal adjustments. The adaptive error handling mechanism 150 can use the iteration count (e.g., the iteration tracking count 166 of FIG. 1) as a metric for evaluating the effectiveness of the initial partial matrix 212.

Based on the tracked metrics, the adaptive error handling mechanism 150 can obtain an updated partial matrix 214 corresponding to a different portion of the matrix set 152 from the initial matrix 212. In some embodiments, the adaptive error handling mechanism 150 can generate the updated partial matrix 214 according to the real-time measure 156 of FIG. 1. As an illustrative example, the adaptive error handling mechanism 150 can generate a larger matrix or a specific segment when the real-time measure 156 indicates a worse performing channel than anticipated by the initial matrix 212. The real-time measure 156 can generate the updated partial matrix 214 using the real-time measure 156 as input(s) to a predetermined process/equation. Once obtained, the adaptive error handling mechanism 150 can decode the next accessed data from memory blocks 208 (e.g., groupings of the memory cells in the memory array 116 of FIG. 1) using the updated partial matrix 214. Details of the computations are described below.

### Control Flow

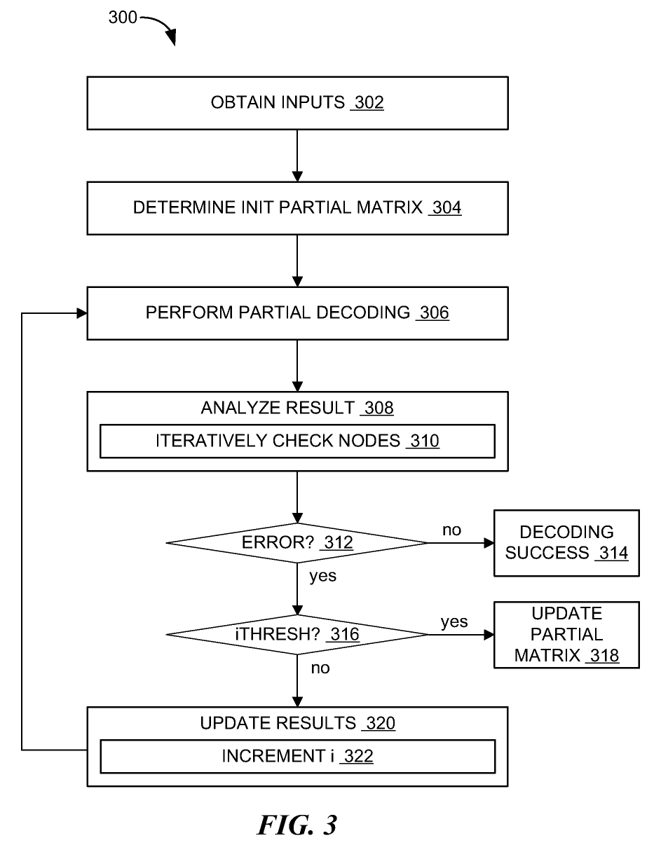

FIG. 3 a flow diagram illustrating an example method 300 of operating an apparatus (e.g., the memory system 102 of FIG. 1, the processor 122 of FIG. 1, the adaptive error handling mechanism 150 of FIG. 1, etc.) in accordance with an embodiment of the present technology. The method 200 can correspond to implementing the adaptive error handling mechanism 150. For example, the method 300 can correspond to performing the ECC computations using the partial matrix 154 of FIG. 1 instead of the full matrix set 152 of FIG. 1.

Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At block 302, the apparatus can obtain the input parameters for the adaptive error handling. The apparatus can obtain the real-time measures 156 of FIG. 1, such as the SNR 158 of FIG. 1, the AMI 160 of FIG. 1, the BER 162 of FIG. 1, or a combination thereof.

For example, the apparatus can compute the SNR 158 based on (1) tracking an estimated sense level for reading the data from the requested read location based on one or more factors (e.g., storage duration, past performance, etc.) as described above, (2) determining the sense level used to read the data, and (3) using the difference in the estimated/expected sense level and the actual sense level to compute the SNR 158. Also, the apparatus can compute the AMI 160 based on tracking the difference between previously accessed initial/raw data values and the corrected result following the ECC computation for the initial raw data. Similarly, the apparatus can track the BER 162 based on the previous ECC computations. Stated differently, the apparatus can use the real-time measures 156 as an input for selecting the initial matrix 212 in addition to or instead of as metrics for evaluating the partial decoding result 164 of FIG. 1.

The apparatus can further obtain the matrix set 152 and the iteration threshold 168 of FIG. 1 (e.g., a maximum number of iterations to be tested) as input parameters. Additionally, the apparatus can initialize the iteration tracking count 166 of FIG. 1, such as to 0, 1, or the iteration threshold 168 (e.g., for a count-down iteration).

At block 304, the apparatus can determine an initial partial matrix, such as the initial partial matrix 212 of FIG. 2. The apparatus (e.g., the matrix selector 206 of FIG. 2) can determine the initial partial matrix according to a predetermined setting. In some embodiments, the apparatus can determine the initial partial matrix as the last-used matrix (e.g., before a power cycle event).

At block 306, the apparatus (via, e.g., the DFU 204 of FIG. 2) can perform a partial decoding. For the initial iteration and until an updating trigger condition occurs, the apparatus can perform the partial decoding using the initial partial matrix. As a result of the partial decoding, the apparatus can generate the partial decoding result 164. For the LDPC example, the apparatus can generate the partial decoding result 164 as a corrected/confirmed set of bits corresponding to the accessed raw data bits. Also, for the LDPC example, the apparatus can use the partial matrix 154 instead of the full H matrix and iteratively perform the ECC computation. According to the LDPC algorithm, the iterative ECC computation can have stages or nodes. Moreover, the LDPC algorithm can utilize a hard bit value (e.g., ‘1’ or a ‘0’ for each bit), a soft bit value (e.g., decimal values that represent a proximity or a confidence level for either a ‘1’ or a ‘0’ determination), or a combination thereof in computing the partial decoding results 164.

At block 308, the apparatus can analyze or evaluate the results (e.g., the partial decoding result 164). In some embodiments, the apparatus can compute the LLR values representative of decoding accuracy for one or more nodes in the ECC computation. For one example, the apparatus can compute the LLR values using the determined hard bits, soft bits, or a combination thereof at each of the nodes. As shown in block 310, the apparatus can iteratively check each of the nodes.

During or as a result of the iterative check, the apparatus can determine whether the partial decoding result 164 includes any errors, such as unnecessary correction of one or more accurate initial bit values and/or failed correction of one or more inaccurate bit values. In some embodiments, the apparatus can determine that the partial decoding result 164 is satisfactory and without errors based on the quantity of hard bit determinations, the soft bit values satisfying a confidence threshold, or a combination thereof. When the partial decoding result 164 is determined to include no error, as illustrated in block 314, the apparatus can determine the partial decoding a success and pass the ECC result as the read data. Moreover, the apparatus can continue to use the most-current partial matrix for subsequent decoding.

Otherwise, when the partial decoding result 164 includes errors, the apparatus can further determine whether the iteration tracking count 166 has reached the iteration threshold 168 as shown in decision block 316. If the iteration threshold 168 has been reached, the apparatus can determine that the currently used partial matrix is inadequate for the actual channel conditions. Accordingly, the apparatus can update the partial matrix 154 as shown in block 318. The apparatus can update the partial matrix by dynamically selecting or computing a different and/or a larger portion of the full H matrix or the matrix set 152. In updating the partial matrix, the apparatus can follow a predetermined selection sequence, algorithm, and/or the like. Moreover, the apparatus may update the real-time measures 156 according to the failed ECC computations and then use the updated measures for the update. Thus, the apparatus can generate the updated partial matrix 214 for use in the current and/or subsequent ECC computations.

When the iteration threshold 168 has not been reached, the apparatus can respond to the decoding failure by updating the analysis results according to one or more predetermined rules as shown in block 320. Effectively, the apparatus can make relatively smaller adjustments to the ECC computation based on the predetermined rules that address more likely or predictable deficiencies of using the partial H matrix instead of the full H matrix.

In some embodiments, the apparatus can update the check nodes and create/adjust C2V messages that correspond to information passed from a check node to a variable node. The apparatus can update according to the intermediate processing results associated with the check node and/or preceding computations. The predetermined rules can effectively dictate how the C2V messages are created or adjusted according to the intermediate results. Additionally or alternatively, the apparatus can further update the LLR values and create/adjust the V2C messages. Similar to the check nodes, the apparatus can follow the predetermined rules that dictate the LLR adjustments and the V2C message creations/adjustments. As an illustrative example, the predetermined rules can have set adjustments or messages for when a particular combination of hard bits and/or soft bits are computed at a certain node.

The apparatus can use the updated results to reperform the partial decoding. In doing so, the apparatus can increment the iteration tracking count 166. Moreover, the apparatus can track the updates so that the updates can be duplicated for subsequent ECC computations.

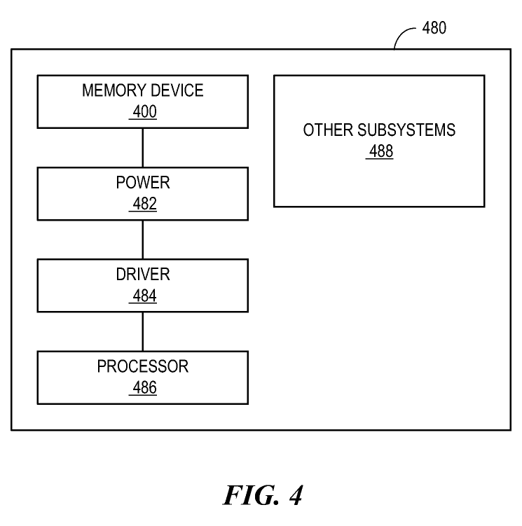

FIG. 4 is a schematic view of a system that includes an apparatus in accordance with embodiments of the present technology. Any one of the foregoing apparatuses (e.g., memory devices) described above with reference to FIGS. 1-3 can be incorporated into any of a myriad of larger and/or more complex systems, a representative example of which is system 480 shown schematically in FIG. 4. The system 480 can include a memory device 400, a power source 482, a driver 484, a processor 486, and/or other subsystems or components 488. The memory device 400 can include features generally similar to those of the apparatus described above with reference to one or more of the FIGS, and can therefore include various features for performing a direct read request from a host device. The resulting system 480 can perform any of a wide variety of functions, such as memory storage, data processing, and/or other suitable functions. Accordingly, representative systems 480 can include, without limitation, hand-held devices (e.g., mobile phones, tablets, digital readers, and digital audio players), computers, vehicles, appliances and other products. Components of the system 480 may be housed in a single unit or distributed over multiple, interconnected units (e.g., through a communications network). The components of the system 480 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash), magnetic storage media, phase-change storage media, ferroelectric storage media, dynamic random access memory (DRAM) devices, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or performance occurring during operation, usage, or deployment of a corresponding device, system or embodiment, and after or while running manufacturer's or third-party firmware. The dynamically occurring processes, functions, actions or performances can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

I claim:

1. A memory device, comprising:
a memory array including memory cells configured to store levels of charges that represent data; and
a controller coupled to the memory array and configured to:
obtain real-time measures representative of current or up-to-current metrics associated with accuracy for accessing and/or decoding the stored data;
determine an initial partial matrix according to the real-time measures, wherein the initial partial matrix is a portion within a full H matrix associated with Low-Density Parity Check (LDPC) Error Correction Code (ECC) computation;
obtain a raw result from the memory array based on existing charge levels associated with a targeted data; and
generate partial decoding result based on performing the ECC computation on the raw result using the initial partial matrix, wherein the partial decoding result corresponds to read data generated in response to a corresponding read or internal access operation.

2. The memory device of claim 1, wherein the real-time measures include a Signal-to-Noise Ratio (SNR), an Average Mutual Information (AMI), a Bit Error Rate (BER), or a combination thereof, wherein:
the SNR includes a metric associated with accessing the raw result;
the AMI includes a metric associated with previous ECC computations; and
the BER includes a metric associated with errors resulting or detected from the previous ECC computations.

3. The memory device of claim 2, wherein:
the SNR is obtained based on a difference between (1) an expected sense level configured to detect the levels of the stored charges in obtaining the raw result and (2) an actual sense level that caused a response in obtaining the raw result; and
the AMI is obtained based on a difference between previous raw data and corresponding ECC outputs from the previous ECC computations.

4. The memory device of claim 3, wherein the controller is configured to determine the initial partial matrix based on:
accessing a set of predetermined portions of the full H matrix and/or a method for dynamically identifying a subgrouping within the full H matrix;
determining the initial partial matrix based on using (1) a comparison between the SNR and the BER, (2) a comparison between the AMI and the BER, or a combination thereof as input to select one of the predetermined portion or identify the subgrouping.

5. The memory device of claim 4, wherein the controller is configured to:
update the SNR, the AMI, the BER, or a combination thereof based on the partial decoding result; and
use the updated result of the SNR, the AMI, the BER, or a combination thereof to evaluate an accuracy of the partial decoding result.

6. The memory device of claim 1, wherein the controller is configured to use the initial partial matrix for subsequent ECC computation when the partial decoding result meets an accuracy threshold.

7. The memory device of claim 1, wherein the controller is configured to:
detect that the partial decoding result fails to satisfy an accuracy threshold; and
in response to failing the accuracy threshold, iteratively (1) analyze the partial decoding result, (2) update intermediate ECC results, and (3) recompute the partial decoding result using the updated intermediate ECC results.

8. The memory device of claim 7, wherein the controller is configured to:
generate the intermediate ECC results according to the LDPC ECC computation, the intermediate ECC results including one or more hard bits, one or more soft bits, or a combination thereof iteratively across a set of processing nodes, wherein each of the hard bits corresponds to a determined ‘0’ or a ‘1’ bit value and each of the soft bits correspond to a determined decimal value corresponding to a confidence level with an estimated ‘0’ or ‘1’ bit value;
analyze the partial decoding result based on computing a likelihood value at each of the processing nodes, wherein the likelihood value represents an accuracy of intermediate processing results at a corresponding node; and
determine whether the partial decoding result satisfies an accuracy threshold based on the likelihood value across one or more of the nodes.

9. The memory device of claim 8, wherein the controller is configured to update the intermediate ECC results according to one or more predetermined rules that identify cross-node messages, node updates, and/or likelihood adjustments for the computed likelihood value according to a combination of the one or more hard bits, the one or more soft bits, and a position of the corresponding processing node to account for using a smaller portion of the H matrix instead of using an entirety of the H matrix.

10. The memory device of claim 9, wherein the controller is configured to:
stop the iterative adjustment and computation after a threshold number of iterations;
update the real-time measures using results of accessing and processing the raw data; and
generate an updated partial matrix that corresponds to a different portion of the H matrix than the initial partial matrix,
wherein the updated partial matrix is generated at least partially based on the updated real-time measures,
wherein the updated partial matrix is configured to replace the initial partial matrix for subsequent LDPC ECC computations.

11. The memory device of claim 10, wherein the controller is configured to:
track an average iteration count for the LDPC ECC computations using the initial partial matrix;
track an updated average iteration count for the subsequent LDPC ECC computations using the updated partial matrix; and
further adjust the updated partial matrix to include a third portion of the H matrix when the updated average iteration count exceeds the average iteration count associated with the initial partial matrix.

12. The memory device of claim 1, wherein the memory device is a NAND Flash device or a Solid State Drive (SSD).

13. A method of operating a memory device that includes memory cells configured to store levels of charge corresponding to stored data, the method comprising:
obtaining real-time measures representative of current or up-to-current metrics associated with accuracies for accessing and/or decoding the stored data;
determining an initial partial matrix according to the real-time measures, wherein the initial partial matrix is a portion within a full H matrix associated with Low-Density Parity Check (LDPC) Error Correction Code (ECC) computation;
obtaining a raw result from the memory cells based on existing charge levels associated with a targeted data; and
generating partial decoding result based on performing the ECC computation on the raw result using the initial partial matrix, wherein the partial decoding result corresponds to read data generated in response to a corresponding read or internal access operation.

14. The method of claim 13, wherein the obtaining real-time measures includes:
determining an expected sense level for detecting the levels of the stored charges in obtaining the raw result;
detecting an actual sense level that caused a response in obtaining the raw result; and
computing a Signal-to-Noise Ratio (SNR) based on a difference between the expected sense level and the actual sense level.

15. The method of claim 13, wherein the obtaining real-time measures includes:
across previous ECC computations, tracking differences between accessed raw data and corresponding ECC results; and
computing an Average Mutual Information (AMI) based on the tracked differences.

16. The method of claim 13, wherein:
the real-time measures include a Signal-to-Noise Ratio (SNR), an Average Mutual Information (AMI), and a Bit Error Rate (BER); and
the initial partial matrix is determined based on using (1) a comparison between the SNR and the BER, (2) a comparison between the AMI and the BER, or a combination thereof as input to select one from a set of predetermined portions of the full H matrix.

17. The method of claim 13, further comprising:
obtaining a second raw result from the memory array in response to a corresponding read operation; and
using the partial matrix for decoding the second raw result when the partial decoding result meets an accuracy threshold.

18. The method of claim 13, further comprising:
detecting that the partial decoding result fails to satisfy an accuracy threshold; and
in response to failing the accuracy threshold, iteratively (1) analyzing the partial decoding result, (2) updating intermediate ECC results, and (3) recomputing the partial decoding result using the updated intermediate ECC results.

19. An apparatus, comprising:
an interface configured to access raw data that corresponds to a target data;
a logic circuit coupled to the interface and configured to decode the raw data to recover the target data according to a decoding algorithm that is associated with a full set of decoding information, the logic circuit configured decode based on:
obtaining real-time measures representative of data degradation associated with one or more channels used to accessing the raw data;
determining a partial information using the real-time measures as inputs for the determination, wherein the partial information corresponds to a portion or a subset of the full set of decoding information that matches the real-time measures according to a predetermined rule or grouping;
recovering the target data based on decoding the accessed raw data using the partial information instead of the full set of decoding information.

20. The apparatus of claim 19, wherein:
the full set of decoding information is a parity-check matrix;
the partial information is a smaller matrix matching a portion of the parity-check matrix, wherein at least one dimension the smaller matrix is smaller than the parity-check matrix; and
the real-time measures includes (1) a Signal-to-Noise Ratio (SNR) corresponding to a level of noise introduced by the one or more channels into the raw data and (2) an Average Mutual Information (AMI) corresponding to an average of differences in data before and after previous ECC computations.
